(19) United States
(12) Patent Application Publication
(10) Pub. No.: US 2024/0070778 A1
(43) Pub. Date: Feb. 29, 2024

(54) METHODS AND SYSTEMS FOR GENERATING DATA ON CRYPTOCURRENCIES

(71) Applicant: Royal Bank of Canada, Toronto (CA)

(72) Inventors: Abbas Hasan, London (CA); Jack Peplinski, Calgary (CA); Luciana Eleuterio Soares Yokota, Toronto (CA); Sakshi Padhiar, Etobicoke (CA)

(21) Appl. No.: 18/453,544

(22) Filed: Aug. 22, 2023

Related U.S. Application Data
(60) Provisional application No. 63/400,268, filed on Aug. 23, 2022.

(51) Int. Cl. G06Q 40/04

(52) U.S. Cl. CPC G06Q 40/04

(57) ABSTRACT

A method of generating data on cryptocurrencies is described. Using one or more computer processors, a request to display a benchmark index relating to the cryptocurrencies is received. In response to receiving the request, for each of the cryptocurrencies, a market capitalization value and a price of the cryptocurrency over time are determined. Based on the market capitalization values and the prices over time, the benchmark index is generated and then displayed. In addition, based on the total value of one or more cryptocurrencies over a past period of time, the future price of the one or more cryptocurrencies over the future period of time may be predicted.

### FIELD

The present disclosure relates to data processing and in particular to methods and systems for generating data on cryptocurrencies.

### BACKGROUND

Digital assets and blockchains have emerged as relevant technologies and areas of interest in capital markets. In particular, cryptocurrencies have grown in popularity over the last two years as various coins and tokens have exploded in value. While cryptocurrencies seem to have entered finance's collective conscience, institutional investor confidence in the ecosystem has remained lukewarm. Financial service providers may therefore wish to deliver to their clients a sense of confidence when navigating this emergent space.

### SUMMARY

According to a first aspect, there is provided a method of generating data on cryptocurrencies, comprising performing, by one or more computer processors: receiving a request to display a benchmark index relating to the cryptocurrencies; in response to receiving the request, for each of the cryptocurrencies: determining a market capitalization value and a price of the cryptocurrency over time; generating the benchmark index based on the market capitalization values and the prices over time; and displaying the benchmark index.

Determining the market capitalization value may comprise: determining a stock price of the cryptocurrency; determining a number of outstanding shares of the cryptocurrency; and determining the market capitalization value based on the stock price and the number of outstanding shares.

Generating the benchmark index may comprise: for each cryptocurrency, determining Weight_A(t)=Market_Cap_A(t)/(Total_Index_Market_Cap(t)*100), wherein Weight_A(t) is a weight over time associated with the cryptocurrency, Market_Cap_A(t) is the market capitalization value over time for the cryptocurrency, and Total_Index_Market_Cap(t) is a sum of each determined Market_Cap_A(t); for each cryptocurrency, multiplying the weight over time associated with the cryptocurrency with the price over time of the cryptocurrency; and summing the weights over time multiplied by the prices over time.

The method may further comprise: determining a global equities index; determining a return of the global equities index; determining a return of the benchmark index; determining a linear relationship between the return of the global equities index and the return of the benchmark index; and determining, based on the linear relationship, a residual risk.

Determining the return of the global equities index may comprise determining a ratio of the global equities index at a time T and the global equities index at a time T−1, wherein T is a unit of time.

Determining the return of the benchmark index may comprise determining a ratio of the benchmark index at a time T and the benchmark index at a time T−1, wherein T is a unit of time.

Determining the residual risk may comprise: determining return(A)−(Slope*return(B)+intercept), wherein return(A) is the return of the benchmark index, Slope is a slope of the linear relationship, return(B) is the return of the global equities index, and intercept is the intercept of the linear relationship.

The method may further comprise: determining a sentiment index; determining a return of the sentiment index; determining a return of the benchmark index; determining a linear relationship between the return of the sentiment index and the return of the benchmark index; and determining, based on the linear relationship, a residual risk.

Determining the return of the sentiment index may comprise determining a ratio of the sentiment index at a time T and the sentiment index at a time T−1, wherein T is a unit of time.

Determining the return of the benchmark index may comprise determining a ratio of the benchmark index at a time T and the benchmark index at a time T−1, wherein T is a unit of time.

Determining the residual risk may comprise: determining return(A)−Slope*return(B)+intercept, wherein return(A) is the return of the benchmark index, Slope is a slope of the linear relationship, return(B) is the return of the sentiment index, and intercept is the intercept of the linear relationship.

Determining the sentiment index may comprise: retrieving keyword analysis performed on one or more social media networks; and determining the sentiment index based on the keyword analysis.

Retrieving the keyword analysis may comprise: performing the keyword analysis on the one or more social media networks.

According to a further aspect, there is provided a method of generating data on one or more cryptocurrencies, comprising performing, by one or more computer processors: receiving a request to predict a future price of the one or more cryptocurrencies over a future period of time; in response to receiving the request, identifying a number of past transactions relating to the one or more cryptocurrencies; determining, based on the number of past transactions, a total value of the one or more cryptocurrencies over a past period of time; and predicting, based on the total value of the one or more cryptocurrencies over the past period of time, the future price of the one or more cryptocurrencies over the future period of time.

Predicting the future price of the one or more cryptocurrencies over the future period of time may comprise predicting the future price of the one or more cryptocurrencies over the future period of time using a machine learning model.

The machine learning model may be a transformers machine learning model.

According to a further aspect of the disclosure, there is provided a non-transitory computer-readable medium having stored thereon computer program code configured, when executed by one or more processors, to cause the one or more processors to perform any of the above-described methods.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 depicts a computer network that comprises a system for generating data on cryptocurrencies, according to an embodiment of the disclosure.

FIG. 2 is a block diagram of a server comprised in the system depicted in FIG. 1, according to an embodiment of the disclosure.

FIG. 3 is a block diagram of hardware and software components used for generating data on cryptocurrencies, according to an embodiment of the disclosure.

FIG. 4 is a flow diagram of a method of obtaining market data relating to cryptocurrencies, according to an embodiment of the disclosure.

FIG. 5 is a diagram of a method of determining a benchmark index for cryptocurrencies, according to an embodiment of the disclosure.

FIG. 6 is a flow diagram of a method of predicting a future price of cryptocurrencies, according to an embodiment of the disclosure.

FIG. 7 is a flow diagram of a first method of determining a residual risk associated with cryptocurrencies, according to an embodiment of the disclosure.

FIG. 8 is a flow diagram of a second method of determining a residual risk associated with cryptocurrencies, according to an embodiment of the disclosure.

FIG. 9 is a flow diagram depicting a user's interaction with a user interface for displaying generated data on cryptocurrencies, according to an embodiment of the disclosure.

FIG. 10 is a plot of a benchmark index relating to cryptocurrency-weighted market capitalization, according to an embodiment of the disclosure.

FIG. 11 is a plot of a predicted future price of a cryptocurrency, according to an embodiment of the disclosure.

### DETAILED DESCRIPTION

The present disclosure seeks to provide methods and systems for generating data on cryptocurrencies. While various embodiments of the disclosure are described below, the disclosure is not limited to these embodiments, and variations of these embodiments may well fall within the scope of the disclosure which is to be limited only by the appended claims.

Generally, according to embodiments of the disclosure, there are described methods and systems that may leverage common platforms and databases to analyze the impact of cryptocurrencies for clients of, and for different internal lines of business within, a financial services institution. According to some embodiments, systems described herein may comprise a web-based application configured to display a dashboard for viewing by a user. The data generated by the system may provide clients of the financial services institution with confidence when navigating the cryptocurrency ecosystem. Furthermore, systems described herein may provide factor analysis, allowing portfolio managers and financial advisors to analyze their portfolios against residual factors unique to cryptocurrencies, such as equity and regulations. Systems described herein may be furthermore configured to generate and display a weighted benchmark index of various cryptocurrencies, and may additionally offer a price prediction model that leverages blockchain transactions and their associated values to predict the future price of one or more cryptocurrencies.

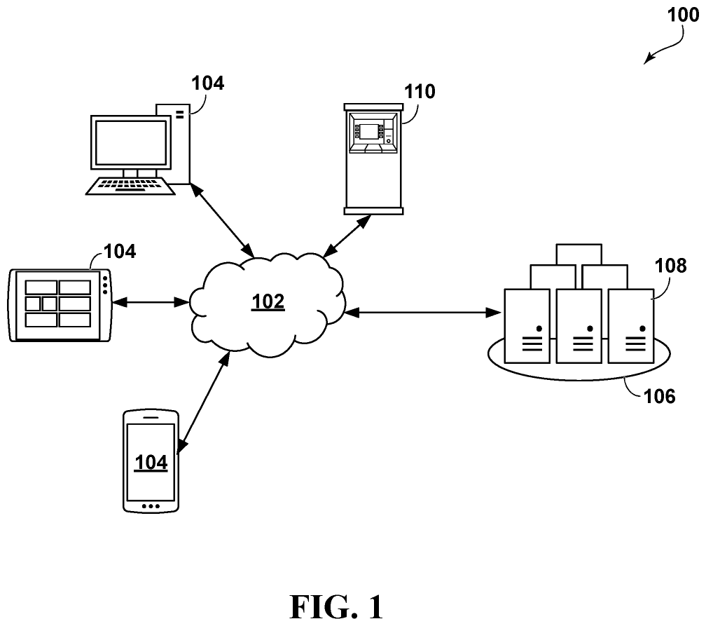

Referring now to FIG. 1, there is shown a computer network 100 that comprises an example embodiment of a system 100 generating data on cryptocurrencies. More particularly, computer network 100 comprises a wide area network 102 such as the Internet to which various user devices 104, an ATM 110, and a data center 106 are communicatively coupled. Data center 106 comprises a number of servers 108 networked together to collectively perform various computing functions. For example, in the context of a financial institution such as a bank, data center 106 may host online banking services that permit users to log in to servers 108 using user accounts that give them access to various computer-implemented banking services, such as online fund transfers. Furthermore, individuals may appear in person at ATM 110 to withdraw money from bank accounts controlled by data center 106.

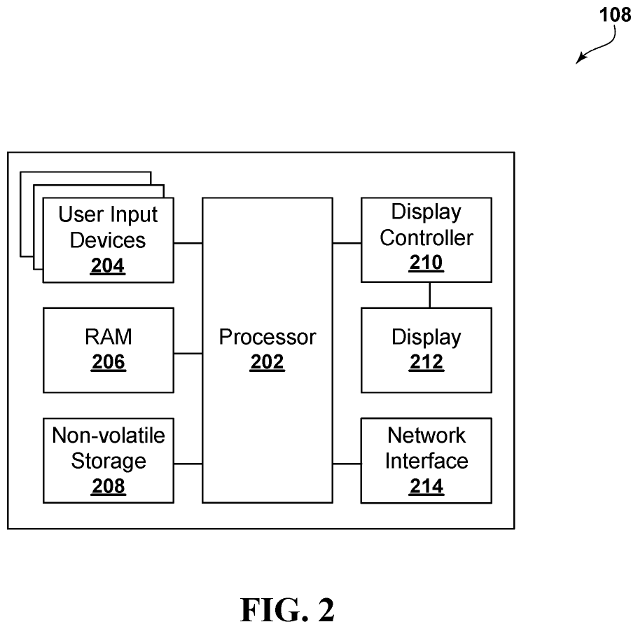

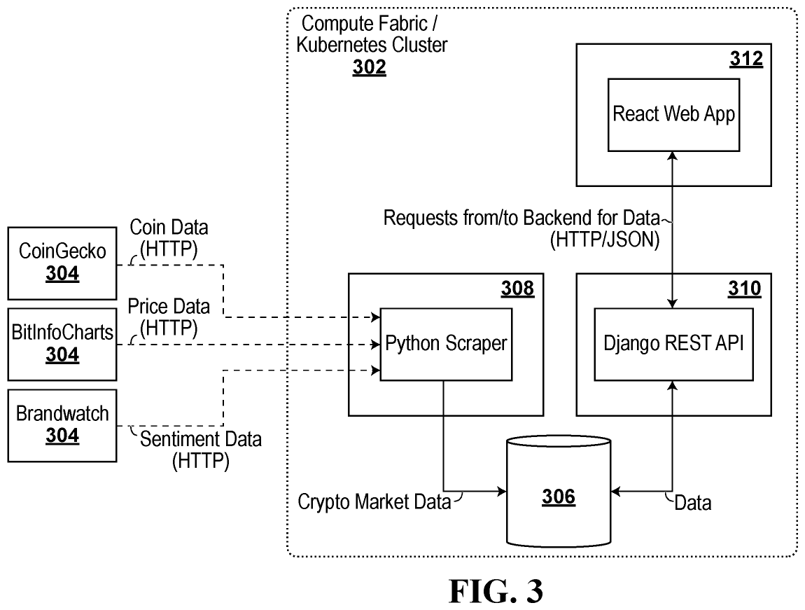

Referring now to FIG. 2, there is depicted an example embodiment of one of the servers 108 that is comprised in data center 106. The server 108 comprises a processor 202 that controls the server 108's overall operation. Processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with wide area network 104 and the other servers 108 in the data center 106. Non-volatile storage 208 has stored on it computer program code that is loaded into RAM 206 at runtime and that is executable by processor 202. When the computer program code is executed by processor 202, processor 202 causes the server 108 to implement one or more methods for generating data on cryptocurrencies, such as is described in more detail below and in connection with FIGS. 3-8. Additionally or alternatively, servers 108 may collectively perform the one or more methods for generating data on cryptocurrencies using distributed computing. While the system depicted in FIG. 2 is described specifically in connection with one of the servers 108, analogous versions of the system may also be used for user devices 104.

Turning to FIG. 3, there is shown a block diagram of hardware and software components used for generating data on cryptocurrencies, according to an embodiment of the disclosure.

Within a computer system 302 (such as a Kubernetes cluster), a Python scraper 308 (or, more generally, a web scraper configured to extract data from websites) is used to fetch data from one or more external sources 304. For example, Python scraper 308 may fetch, on a daily or some other temporal basis, data relating, for example, to market capitalizations, prices of cryptocurrencies, values of cryptocurrency transactions, and hashrates. As can be seen in FIG. 3, external sources 304 include CoinGecko and Bitinfocharts, or one or more other platforms that may provide information and analytics about various cryptocurrencies, exchanges, and blockchain projects, including the current market capitalization (“market cap”) and price of each of one or more cryptocurrencies. External sources 304 further include Brandwatch or another social media monitoring and analytics platform designed to be used for the analysis of online conversations about brands, products, or industry.

The retrieved data is then passed from Python scraper 308 to a database 306. Meanwhile, a user may interact with a frontend web application 312 (such as a web application built using the React JavaScript library) to extract and process data from database 306, via a backend API 310 (for example an API built using Django REST Framework (DRF)). In particular, in response to receiving a request from the user via web application 312, backend API 310 may fetch the requested data from database 306.

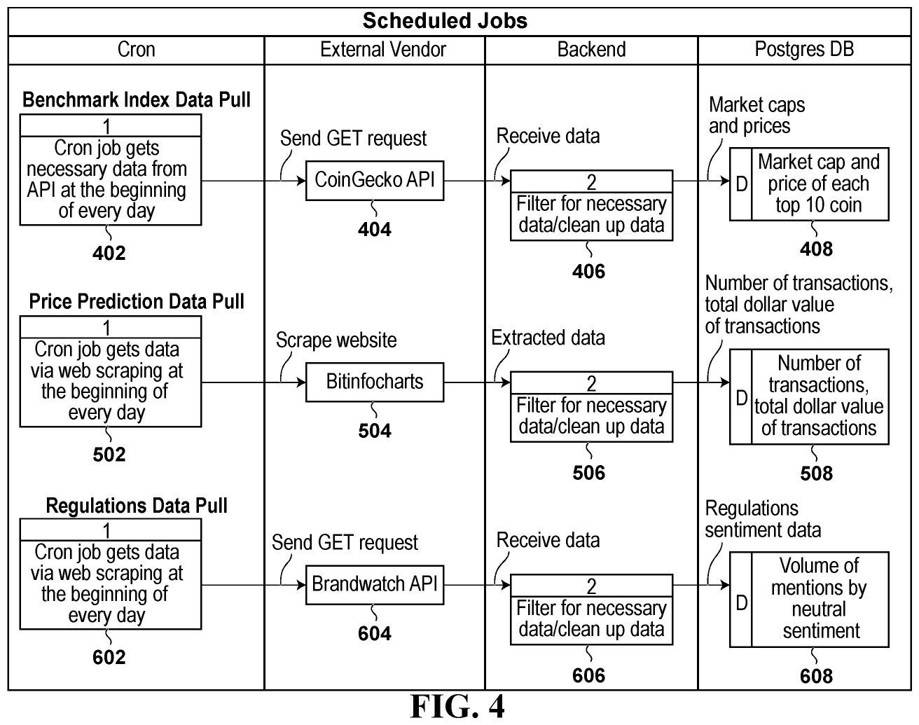

Turning to FIG. 4, there is now described a flow diagram of a method of obtaining market data relating to cryptocurrencies, performed by various components of computer system 302, and according to an embodiment of the disclosure.

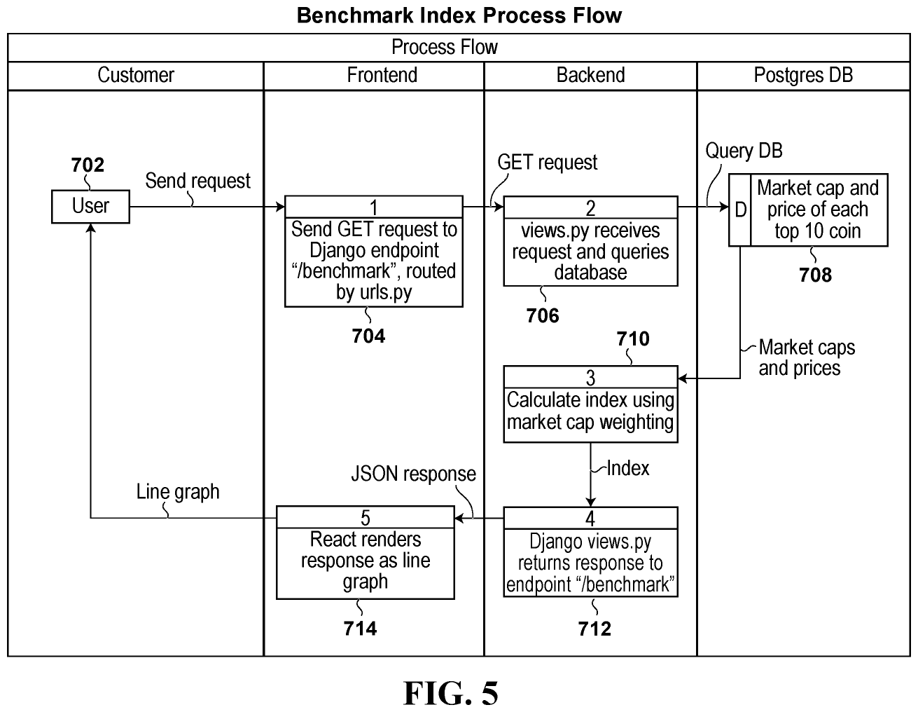

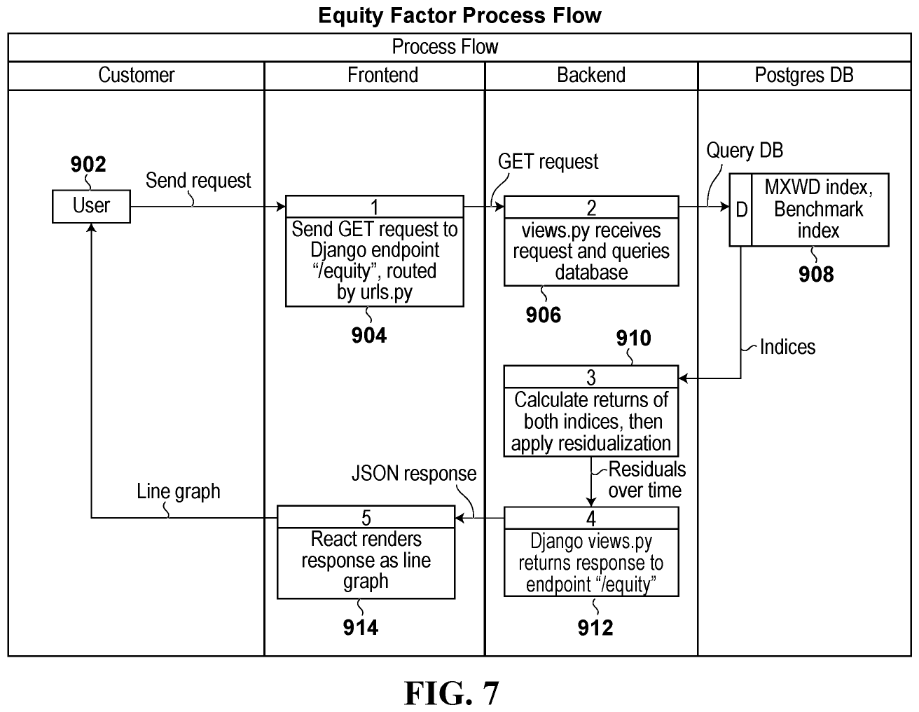

In order to retrieve data used for calculating a benchmark index of cryptocurrencies (as described in further detail below in connection with FIGS. 5 and 7)), the process begins by retrieving the daily market cap and daily price for each of one or more cryptocurrencies (“coins”). At block 402, scraper 308 transmits to a source 304 (such as CoinGecko) a daily request for the current market cap and price of each of one or more coins. At block 404, source 304 receives the request and transmits the requested data to scraper 308. At block 406, scraper 308 filters/cleans up the received data and passes the cleaned data to database 306. At block 408, the cleaned data is stored in database 306 for later use by a user interacting with frontend web application 312.

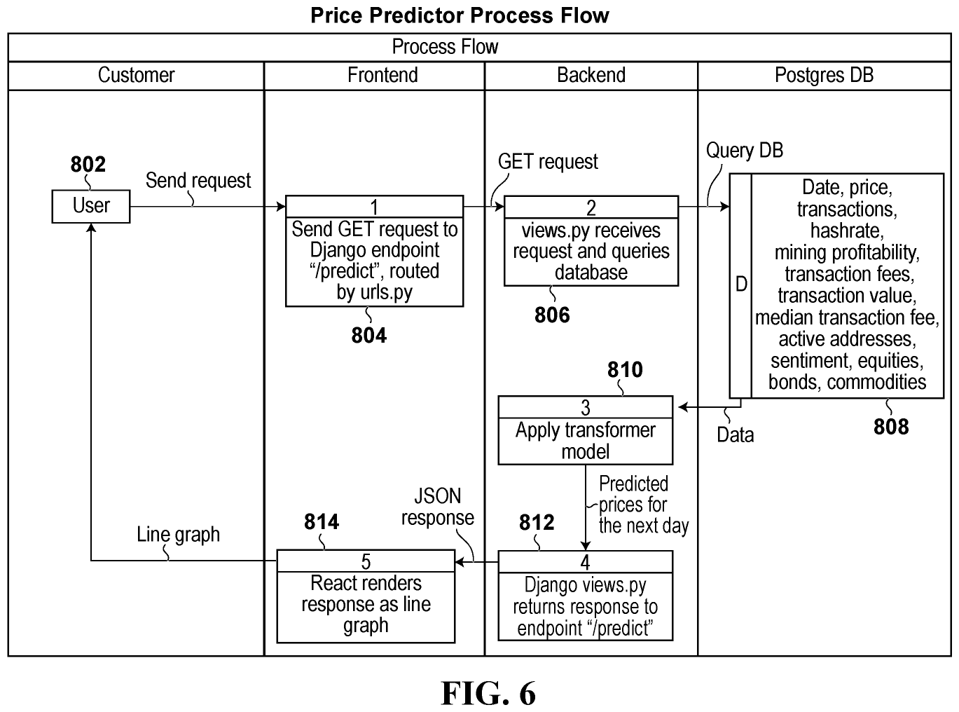

In order to retrieve data used for predicting the future price of a cryptocurrency (as described in further detail below in connection with FIG. 6), the process begins by retrieving, for a given cryptocurrency, a number of past transactions and their associated values. At block 502, scraper 308 transmits to a source 304 (such as Bitinfocharts) a request for the number of past transactions and their associated values. At block 504, source 304 receives the request and transmits the requested data to scraper 308. At block 506, scraper 308 filters/cleans up the received data and passes the cleaned data to database 306. At block 508, the cleaned data is stored in database 306 for later use by a user interacting with frontend web application 312.

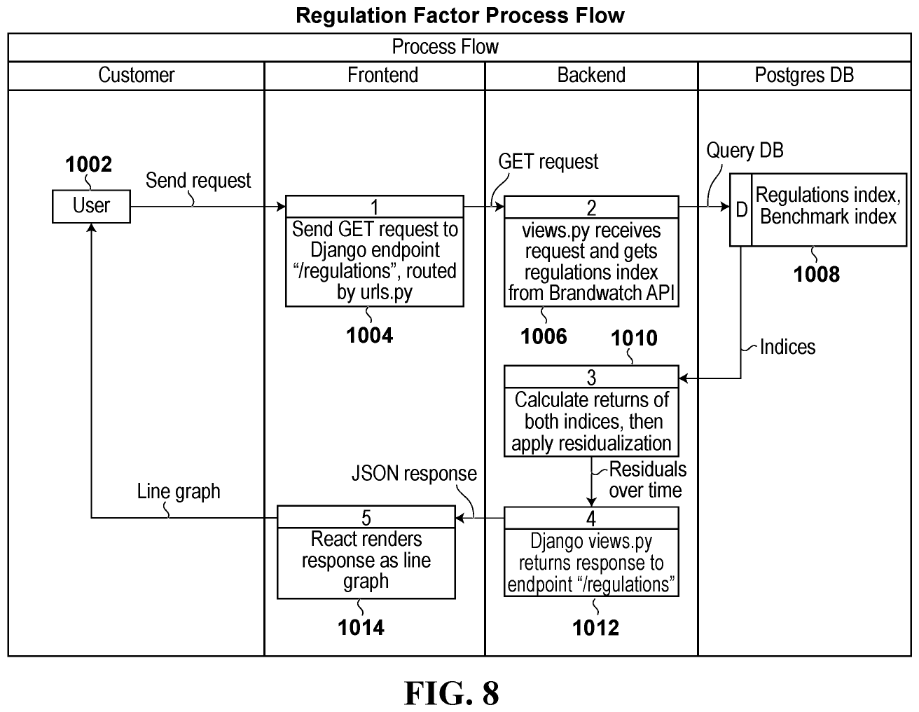

In order to retrieve data used for calculating a regulation factor (as described in further detail below in connection with FIG. 8), the process begins by retrieving keyword analysis performed on one or more social media networks. At block 602, scraper 308 transmits to a source 304 (such as Brandwatch) a request for the keyword analysis. At block 604, source 304 receives the request and transmits the requested data to scraper 308. At block 606, scraper 308 filters/cleans up the received data and passes the cleaned data to database 306. At block 608, the cleaned data is stored in database 306 for later use by a user interacting with frontend web application 312.

### Benchmark Index Generation

Turning to FIG. 5, there is shown a method of generating a benchmark index relating to one or more cryptocurrencies, according to an embodiment of the disclosure

The benchmark index is an index that is weighted based on the market capitalization (“market cap”) of one or more cryptocurrencies (“coins”), and for example the cryptocurrencies Bitcoin, Ethereum, Tether, USD Coin, Binance Coin, Binance USD, Ripple, Cardano, Solana, and Dogecoin. This benchmark index may provide an overall view of the cryptocurrency market.

For each coin, the market cap is calculated by multiplying the stock price of the coin by the number of the coin's outstanding shares. To obtain the total market cap, all of the market cap values are added together. These variables may then be used to calculate a weight for each coin as follows:

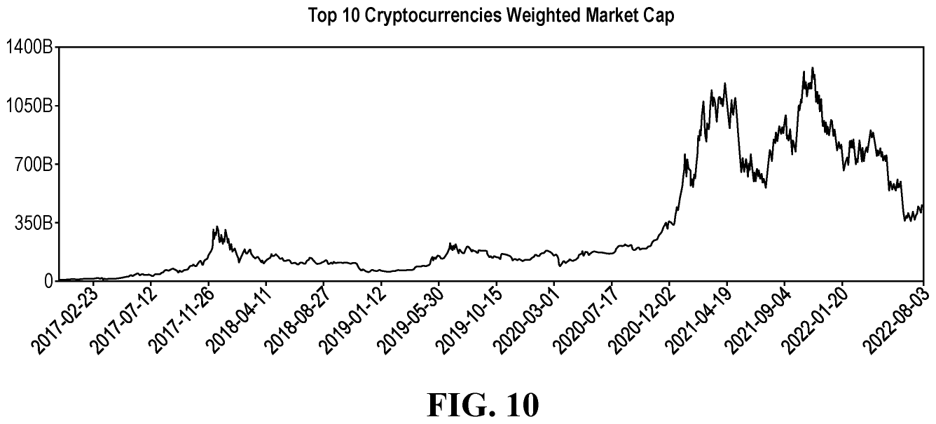

Weight_A(t)=Market_Cap_A(t)/[Total_Index_Market_Cap(t)*100],

wherein Weight_A is the weight for a given coin A, t is a given day, Market_Cap_A is the market cap for the coin A, and Total_Index_Market_Cap is the sum of the determined market caps (i.e. the sum of the market cap determined for each coin). Subsequently, for each day, the price of each coin is multiplied by its respective weight, and the sum of these values determines the benchmark index. In other words, the benchmark index may be calculated based on summing, across all coins A, Weight_A(t)*Price_A(t). The benchmark index may be presented on a display, and for example the display may show an x-axis representing time and a y-axis representing the benchmark index. An example of the calculated benchmark index varying over time is shown in FIG. 10.

With specific reference to FIG. 5, at block 702, a user initiates, via web application 312, a request to calculate the benchmark index. At block 704, web application 312 forwards the request to backend API 310. At block 706, using the request, backend API 310 queries database 306. At block 708, the market cap and price (over time) of each coin is fetched from database 306 and returned to backend API 310. At block 710, computer system 302 determines the benchmark index based on the weighted market cap and price of each coin, using the above-described method. At block 712, backend API 310 returns the calculated benchmark index to web application 312. At block 714, web application 312 renders for viewing, by the user, a plot of the benchmark index over time.

### Predicting Future Price of Cryptocurrencies

According to some embodiments of the disclosure, systems described herein may be configured to predict a price of a coin based on a past price of the coin.

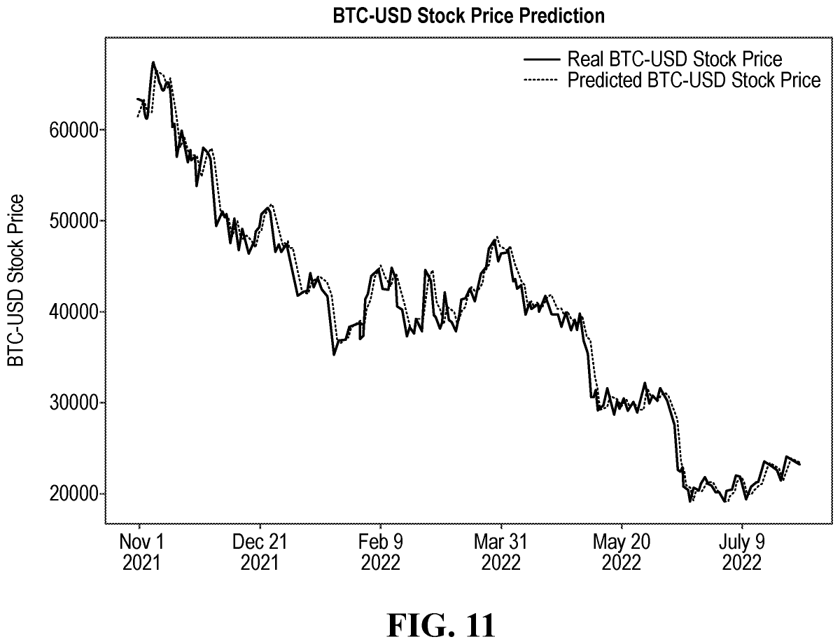

Referring now to FIG. 6, the process of predicting the future price of a given coin is based on the number of past transactions relating to the coin and the total value of these transactions. These factors may hold value in the movement of coin prices, as supported by the constant “pump and dump” nature of coin prices. These factors are processed and used in a transformers machine learning model in order to predict coins' future prices, for example for the following week. An example of the calculated price prediction is shown in FIG. 11, showing the predicted price of Bitcoin (generated using the method described herein) compared to the actual price of Bitcoin over the same period.

With specific reference to FIG. 6, at block 802, a user initiates, via web application 312, a request to predict the future price of a coin. At block 804, web application 312 forwards the request to backend API 310. At block 806, using the request, backend API 310 queries database 306. At block 810, the data required for the prediction is fetched from database 306 and returned to backend API 310. In particular, the data includes data indicative of a number of past transactions relating to the coin, and the total value of these transactions. Other fetched data may include data relating to date, price, transactions, hashrate, mining profitability, transaction fees, transaction values, median transaction fees, active addresses, sentiment, equities, bonds, and commodities. At block 810, the retrieved data is input to a trained transformers machine learning model which generates a prediction of a future price of the coin over a future period of time (such as the next 24 hours). At block 812, backend API 310 returns the generated predicted price to web application 312. At block 814, web application 312 renders for viewing, by the user, a plot of the predicted price over time.

### Factor Lens

According to some embodiments of the disclosure, systems described herein may be configured to determine how risk factors may affect the price of cryptocurrencies. Graphs or similar outputs may be generated to illustrate the movement of prices of coins while excluding the impact of one or both of equity and regulations.

### (a) Equity

In order to show how equity affects the price movement of cryptocurrencies, two indices are used: one representing the cryptocurrency market and another representing the equities market. The index representing the cryptocurrency market may be the benchmark index described above, while the index representing the equities market may be obtained through some other means; for example, Morgan Stanley Capital International's flagship global equities index (MXWD) may be used.

Prior to conducting any analysis on these indices, the return of each index is calculated using the following formula:

Return=Index(t)/Index(t)−1,

wherein t is the current date. Subsequently, one or more parameters that define a linear relationship between the two indices are calculated using, for example, the least-squares method (i.e. linear regression). The one or more parameters may include slope, intercept, the Pearson correlation coefficient, p-value for a hypothesis test, standard error of the slope, and standard error of the intercept. Based on these parameters, a residual risk can be calculated using the following equation:

Residual Risk=Return_A−(Slope*Return_B+Intercept),

wherein A is the benchmark index and B is the index representing the equities market (e.g. the MXWD index). The residual risk may then be plotted over time, with the output being displayed to a user.

With specific reference to FIG. 7, at block 902, a user initiates, via web application 312, a request to determine an equity-based residual risk. At block 904, web application 312 forwards the request to backend API 310. At block 906, using the request, backend API 310 queries database 306. At block 908, the benchmark index (determined using the method described above) and the MXWD index are fetched from database 306 and returned to backend API 310. At block 910, computer system 302 determines the returns of both indices, and the associated residual risks, using the above-described method. At block 912, backend API 310 returns the calculated residual risks to web application 312. At block 914, web application 312 renders for viewing a graph displaying the residual risk of equities over time.

### (b) Regulations

In order to show how regulations affect the price movement of cryptocurrencies, two indices are used: one representing the cryptocurrency market and the other representing the general public sentiment towards regulations regarding cryptocurrency. The index representing the cryptocurrency market may be the benchmark index described above, while the index representing the general public sentiment towards regulations regarding cryptocurrency may be obtained based on keyword analysis performed on the output of one or more social media networks, for example Twitter®.

Prior to conducting any analysis on these indices, the return of each index is calculated using the following formula:

Return=Index(t)/Index(t)−1,

wherein t is the current date. Subsequently, one or more parameters that define a linear relationship between the two indices are calculated using, for example, the least-squares method (i.e. linear regression). The one or more parameters may include slope, intercept, the Pearson correlation coefficient, p-value for a hypothesis test, standard error of the slope, and standard error of the intercept. Based on these parameters, a residual risk can be calculated using the following equation:

Residual Risk=Return_A−(Slope*Return_B+Intercept),

wherein A is the benchmark index and B is the index representing the general public sentiment towards regulations regarding cryptocurrency. The residual risk may then be plotted over time, with the output being displayed to a user.

With specific reference to FIG. 8, at block 1002, a user initiates, via web application 312, a request to determine a regulations-based residual risk. At block 1004, web application 312 forwards the request to backend API 310. At block 1006, using the request, backend API 310 queries database 306. At block 1008, the benchmark index (determined using the method described above) and the index representing the general public sentiment towards regulations regarding cryptocurrency are fetched from database 306 and returned to backend API 310. At block 1010, computer system 302 determines the returns of both indices, and the associated residual risks, using the above-described method. At block 1012, backend API 310 returns the calculated residual risks to web application 312. At block 1014, web application 312 renders for viewing a graph displaying the residual risk of cryptocurrency regulations over time.

User Interaction with System

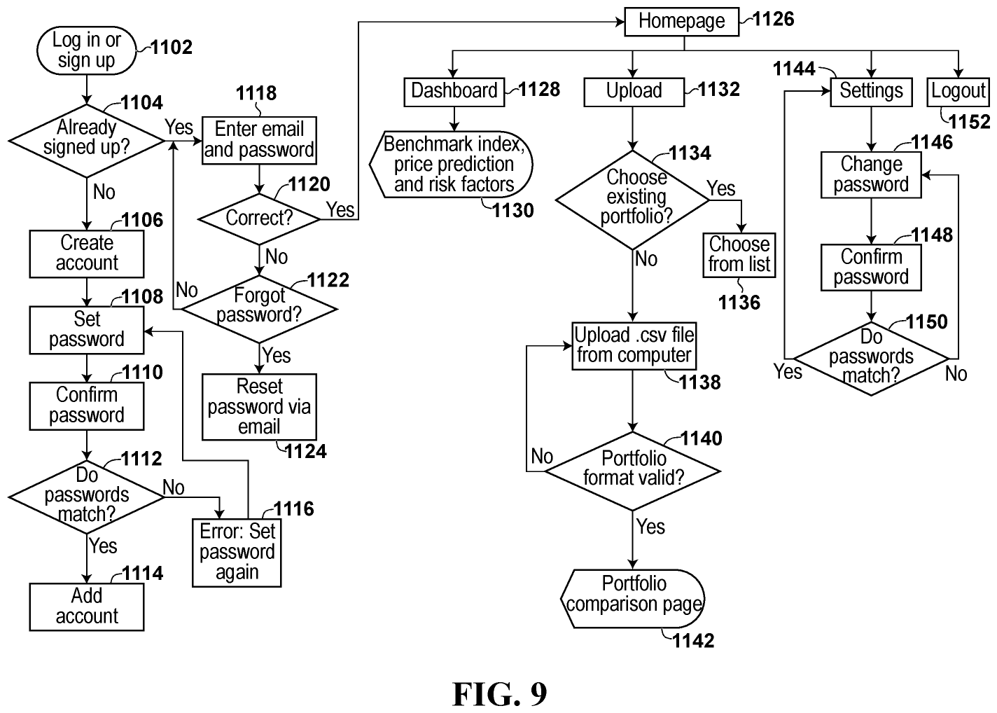

Turning to FIG. 9, there is shown a flow diagram illustrating an example sequence of steps that may be taken by a user interacting with computer system 302.

At block 1102, a user decides to log into or sign up to computer system 302 by providing suitable input to computer system 302.

At block 1104, computer system 302 determines whether the user has opted to log into or sign up to computer system 302.

At block 1106, if the user does not currently have an account with computer system 302, then the user is prompted to create an account, for example by entering their e-mail address.

At block 1108, the user is prompted to select a password for their account.

At block 1110, the user is prompted to confirm their selected password.

At block 1112, computer system 302 determines whether the passwords entered at blocks 1108 and 1110 match.

If the passwords match, then at block 1114 the account is created.

If the passwords do not match, then at block 1116 the user is advised of an error and the process returns to block 1108.

At block 1118, if the user already has an account with computer system 302, then the user is prompted to enter their e-mail address and password.

At block 1120, computer system 302 determines whether the e-mail address and password are the same e-mail address and password that were entered when the account was created.

If the e-mail address and password are not the same e-mail address and password that were entered when the account was created, then at block 1122 the user is prompted to advise whether they have forgotten their password.

If the user has forgotten their password, then at block 1124 the user is prompted to reset their password for their account, for example by accessing a link provided to their e-mail address.

If the user has not forgotten their password, then the process returns to block 1118.

If the e-mail address and password are the same e-mail address and password that were entered when the account was created, then at block 1126 the user is taken to a homepage.

From the homepage, the user may access any of various services provided by computer system 302. For example, at block 1128, the user may access a dashboard. At block 1130, the dashboard may display, using any of the methods described above, one or more of a weighted benchmark index, one or more predictions of future prices of one or more cryptocurrencies, and the effect of risk factors (such as regulations-based risk or equity-based risk) on cryptocurrencies.

At block 1132, the user may elect to upload details of one or more financial portfolios to computer system 302.

At block 1134, computer system 302 may determine whether the user is opting to upload any portfolios that are already accessible by computer system 302.

If the user is opting to upload any portfolios that are already accessible by computer system 302, then at block 1136 computer system 302 prompts the user to select any such portfolios from a list presented by computer system 302.

If the user is opting to upload any portfolios that are not accessible by computer system 302, then at block 1138 the user is prompted to upload any such portfolios in a .csv format.

At block 1140, computer system 302 determines whether the format of the portfolio(s) being uploaded is a .csv format.

If the format of the portfolio(s) being uploaded is a .csv format, then at block 1142 the user is taken to a portfolio comparison page.

If the format of the portfolio(s) being uploaded is not a .csv format, then the process returns to block 1138.

At block 1144, the user may elect to adjust one or more settings.

At block 1146, the user may elect to change their password and may enter a new password.

At block 1148, the user is prompted to confirm their changed password.

At block 1150, computer system 302 determines whether the passwords entered at blocks 1146 and 1148 match.

If the passwords match, then the user's password is changed and the user is returned to the settings page at block 1144.

If the passwords do not match, then the process returns to block 1146.

At block 1152, the user may elect to log out of their account.

The outputs generated by computer system 302 described herein may be used for different purposes. For example, users may obtain an overall view of the cryptocurrency market and may visually analyze and compare the performance of cryptocurrency to the performance of another financial portfolio. Predicting the price of a coin may also enable users to make better investment decisions, and may allow users to better advise their clients on investment decisions. Further still, users may analyze the performance of cryptocurrency portfolios independently of risk factors such as equity and regulations.

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of generating data on cryptocurrencies, comprising performing, by one or more computer processors:
receiving a request to display a benchmark index relating to the cryptocurrencies;
in response to receiving the request, for each of the cryptocurrencies:
determining a market capitalization value and a price of the cryptocurrency over time;
generating the benchmark index based on the market capitalization values and the prices over time; and
displaying the benchmark index.

2. The method of claim 1, wherein determining the market capitalization value comprises:
determining a stock price of the cryptocurrency;
determining a number of outstanding shares of the cryptocurrency; and
determining the market capitalization value based on the stock price and the number of outstanding shares.

3. The method of claim 1, wherein generating the benchmark index comprises:
for each cryptocurrency, determining Weight_A(t)=Market_Cap_A(t)/(Total_Index_Market_Cap(t)*100), wherein Weight_A(t) is a weight over time associated with the cryptocurrency, Market_Cap_A(t) is the market capitalization value over time for the cryptocurrency, and Total_Index_Market_Cap(t) is a sum of each determined Market_Cap_A(t);
for each cryptocurrency, multiplying the weight over time associated with the cryptocurrency with the price over time of the cryptocurrency; and
summing the weights over time multiplied by the prices over time.

4. The method of claim 1, further comprising:
determining a global equities index;
determining a return of the global equities index;
determining a return of the benchmark index;
determining a linear relationship between the return of the global equities index and the return of the benchmark index; and
determining, based on the linear relationship, a residual risk.

5. The method of claim 4, wherein determining the return of the global equities index comprises determining a ratio of the global equities index at a time T and the global equities index at a time T−1, wherein T is a unit of time.

6. The method of claim 4, wherein determining the return of the benchmark index comprises determining a ratio of the benchmark index at a time T and the benchmark index at a time T−1, wherein T is a unit of time.

7. The method of claim 4, wherein determining the residual risk comprises:
determining return(A)−(Slope*return(B)+intercept), wherein return(A) is the return of the benchmark index, Slope is a slope of the linear relationship, return(B) is the return of the global equities index, and intercept is the intercept of the linear relationship.

8. The method of claim 1, further comprising:
determining a sentiment index;
determining a return of the sentiment index;
determining a return of the benchmark index;
determining a linear relationship between the return of the sentiment index and the return of the benchmark index; and
determining, based on the linear relationship, a residual risk.

9. The method of claim 8, wherein determining the return of the sentiment index comprises determining a ratio of the sentiment index at a time T and the sentiment index at a time T−1, wherein T is a unit of time.

10. The method of claim 8, wherein determining the return of the benchmark index comprises determining a ratio of the benchmark index at a time T and the benchmark index at a time T−1, wherein T is a unit of time.

11. The method of claim 8, wherein determining the residual risk comprises:
determining return(A)−Slope*return(B)+intercept, wherein return(A) is the return of the benchmark index, Slope is a slope of the linear relationship, return(B) is the return of the sentiment index, and intercept is the intercept of the linear relationship.

12. The method of claim 8, wherein determining the sentiment index comprises:
retrieving keyword analysis performed on one or more social media networks; and
determining the sentiment index based on the keyword analysis.

13. The method of claim 12, wherein retrieving the keyword analysis comprises:
performing the keyword analysis on the one or more social media networks.

14. A method of generating data on one or more cryptocurrencies, comprising performing, by one or more computer processors:
receiving a request to predict a future price of the one or more cryptocurrencies over a future period of time;
in response to receiving the request, identifying a number of past transactions relating to the one or more cryptocurrencies;
determining, based on the number of past transactions, a total value of the one or more cryptocurrencies over a past period of time; and
predicting, based on the total value of the one or more cryptocurrencies over the past period of time, the future price of the one or more cryptocurrencies over the future period of time.

15. The method of claim 14, wherein predicting the future price of the one or more cryptocurrencies over the future period of time comprises predicting the future price of the one or more cryptocurrencies over the future period of time using a machine learning model.

16. The method of claim 15, wherein the machine learning model is a transformers machine learning model.

17. A non-transitory computer-readable medium having stored thereon computer program code configured, when executed by one or more processors, to cause the one or more processors to perform a method comprising:
receiving a request to predict a future price of one or more cryptocurrencies over a future period of time;
in response to receiving the request, identifying a number of past transactions relating to the one or more cryptocurrencies;
determining, based on the number of past transactions, a total value of the one or more cryptocurrencies over a past period of time; and
predicting, based on the total value of the one or more cryptocurrencies over the past period of time, the future price of the one or more cryptocurrencies over the future period of time.

18. The non-transitory computer-readable medium of claim 17, wherein predicting the future price of the one or more cryptocurrencies over the future period of time comprises predicting the future price of the one or more cryptocurrencies over the future period of time using a machine learning model.

19. The non-transitory computer-readable medium of claim 18, wherein the machine learning model is a transformers machine learning model.
